(19) United States
(12) Patent Application Publication
(10) Pub. No.: US 2008/0220970 A1
(43) Pub. Date: Sep. 11, 2008

(54) Agrochemical Nanoparticulate Active Ingredient Formulations

(75) Inventors: Ingrid Martin, Ludwigshafen (DE); Helmut Auweter, Limburgerhof (DE); Sebastian Koltzenburg, Dannstadt-Schauernheim (DE); Ansgar Schafer, Karlsruhe (DE); Peter Pfluger, Breunigweiler (DE); Birgit Blanz, Neustadt (DE); Werner A. Goedel, Chemnitz (DE)

Correspondence Address: HUTCHISON LAW GROUP PLLC, PO BOX 31686, RALEIGH, NC, 27612, US

(73) Assignee: BASF SE, Ludwigshafen (DE)

(21) Appl. No.: 12/091,179

(22) PCT Filed: Oct. 17, 2006
(86) PCT No.: PCT/EP2006/067475

§ 371 Date: Apr. 23, 2008

(30) Foreign Application Priority Data
Oct. 27, 2005 (EP) 05023451.7

(51) Int. Cl. A01N 25/04; A01P 13/00; A01P 3/00; A01P 7/04; A01C 1/06

(52) U.S. Cl. 504/100; 504/116.1; 424/484; 424/486; 504/360

(57) ABSTRACT

The present invention comprises aqueous dispersions comprising a nanoparticulate formulation of crop protection agents in which the nanoparticles
have core-shell structures having a mean particle diameter of 0.05 to 2.0 μm and
the crop protection agent is present in the core X-ray amorphous together with one or more polymers, where the polymer is not or only partially soluble in water or aqueous solutions or water/solvent mixtures
and the shell consists of a stabilizing coating matrix,
   preparable by a process which comprises
(a) preparing a solution of the crop protection agent in a water-immiscible organic solvent,
(b) dissolving the core polymer in a water-immiscible organic solvent; and
(c) emulsifying the mixture resulting from (a) and (b) with an aqueous solution comprising components of the coating matrix by injecting the corresponding solutions into a mixing chamber and removing the organic solvent after emulsification.

The present invention comprises aqueous dispersions comprising a nanoparticulate formulation of crop protection agents in which the nanoparticles
have core-shell structures having a mean particle diameter of 0.05 to 2.0 μm and
the crop protection agent is present in the core X-ray amorphous together with one or more polymers, where the polymer is not or only partially soluble in water or aqueous solutions or water/solvent mixtures
and the shell consists of a stabilizing coating matrix,
   preparable by a process which comprises
(a) preparing a solution of the crop protection agent in a water-immiscible organic solvent,
(b) dissolving the core polymer in a water-immiscible organic solvent; and
(c) emulsifying the mixture resulting from (a) and (b) with an aqueous solution comprising components of the coating matrix by injecting the corresponding solutions into a mixing chamber and removing the organic solvent after emulsification;
   solid nanoparticulate formulations obtainable from the abovementioned dispersions, agrochemical formulation of a solid carrier treated with an abovementioned dispersion, processes for treating seed, and/or methods for controlling unwanted vegetation and/or for controlling unwanted infestation by insects or mites on plants and/or for controlling phytopathogenic fungi, which processes and methods are based on the abovementioned dispersions or agrochemical formulations.

Nanoparticulate crop protection formulations as they are known, for example, from EP 932339-A, have a number of advantages; thus, for example, the dissolution rate and the solubility of the nanoparticulate formulations in solvents of agrochemical importance is relatively high. Frequently, it is also possible to reduce the application rates of the crop protection agents used in the nanoparticulate formulations.

If aqueous dispersions of nanoparticulate preparations is prepared, it is desirable that these dispersions remain stable even on prolonged storage and that there is no agglomeration of the particles or particle growth (such as, for example, Ostwald ripening).

However, the storage stability of the nanoparticulate crop protection formulations used in the prior art, in the case that they are dispersed in an aqueous solution and stored for an appropriately long time, provides scope for improvement.

Accordingly, it was an object of the present invention to provide agrochemical formulations having a storage stability which is improved compared to that of the prior art.

This object was achieved by providing aqueous dispersions comprising a nanoparticulate formulation of crop protection agents in which the nanoparticles
have core-shell structures having a mean particle diameter of 0.05 to 2.0 μm, preferably 0.1-0.9 μm, and
the crop protection agent is present in the core X-ray amorphous together with one or more polymers, where the polymer is not or only partially soluble in water or aqueous solutions or water/solvent mixtures
and the shell consists of a stabilizing coating matrix,
   preparable by a process which comprises
(a) preparing a solution of the crop protection agent in a water-immiscible organic solvent,
(b) dissolving the core polymer in a water-immiscible organic solvent; and
(c) emulsifying the mixture resulting from (a) and (b) with an aqueous solution comprising components of the coating matrix by injecting the corresponding solutions into a mixing chamber and removing the organic solvent after emulsification:

The term “water-immiscible organic solvent” describes organic solvents whose solubility in water is less than 50%, preferably less than 25%, particularly preferably less than 10%, very particularly preferably less than 10%, in a most preferred embodiment less than 5%. In a preferred embodiment, the boiling point under standard conditions (pressure 1 bar, 20° C.) is 0-100° C.

The following solvents may be mentioned by way of example, but not by way of limitation: cyclohexane, cyclopentane, pentane, hexane, heptane, 2-methylpentane, 3-methylpentane, 2-methylhexane, 3-methylhexane, 2-methylbutane, 2,3-dimethylbutane, methylcyclopentane, methylcyclohexane, 2,3-dimethylpentane, 2,4-dimethylpentane, benzene, 1-pentene, 2-pentene, 1-hexene, 1-heptene, cyclohexene, 1-butanol, ethyl vinyl ether, propyl ether, isopropyl ether, butyl vinyl ether, butyl ethyl ether, 1,2-epoxybutane, furan, tetrahydropyran, 1-butanal, 2-methylpropanal, 2-pentanone, 3-pentanone, cyclohexanone, fluorobenzene, hexafluorobenzene, ethyl formate, propyl formate, isopropyl formate, ethyl acetate, vinyl acetate, isopropyl acetate, ethyl propionate, methyl acrylate, ethyl acrylate, methyl methacrylate, chloroethane, 1-chloropropane, 2-chloropropane, 1-chlorobutane, 2-chlorobutane, 1-chloro-2-methylpropane, 2-chloro-2-methylpropane, 1-chloro-3-methylbutane, 3-chloropropene, dichloromethane, trichloromethane, tetrachloromethane, 1,1-dichloroethane, 1,2-dichloroethane, 1,2-dichloropropane, 1,1,1-trichloroethane, 1,1-dichloroethylene, 1,2-dichloroethylene, trichloroethylene, bromomethane, 1-bromopropane, 2-bromopropane, 1-bromobutane, 2-bromobutane, 2-bromo-2-methylpropane, bromomethylene, iodomethane, iodoethane, 2-iodopropane, trichlorofluoromethane, dichlorofluoromethane, dibromofluoromethane, bromochloromethane, bromochlorofluoromethane, 1,1,2-trichloro-1,2,2-trifluoroethane, 1,1,2,2-tetrachlorodifluoroethane, 1,2-dibromotetrafluoroethane, 1,2-dibromo-1,1-diflouroethane, 1,1-dichloro-2,2-difluoroethylene, propionitrile, acrylonitrile, methacrylonitrile, triethylamine, carbon disulfide, 1-butanethiol, methyl sulfide, ethyl sulfide and tetramethylsilane.

Preference is given to using dichloromethane and ethyl acetate.

It is also possible to use mixtures of the solvents mentioned above.

Mixing chamber processes are known to the person skilled in the art and described, for example, in WO 05/44221 or EP-A 932339.

In a preferred embodiment, the two components are injected into the mixing chamber in a compact jet.

The mixing process can be carried out batchwise or, preferably, continuously. The mixing process results in the formation of an emulsion.

After the emulsion in step (c), the solvent can be removed by methods known to the person skilled in the art such as, for example, distillation, if appropriate under reduced pressure, or extraction or membrane filtration. Alternatively, the dispersion obtained can be subjected to drying processes known to the person skilled in the art, such as, for example, freeze drying (lyophilization), spray drying or spray granulation.

The core of the nanoparticles according to the invention may consist of one, two, three or more phases.

In a further embodiment of the present invention, the core of the nanoparticies according to the invention consists of at least three phases, one phase consisting of amorphous particles of the crop protection agent and the other phase being a molecularly disperse distribution of the crop protection agent in a polymer matrix and the third phase being a crop protection agent-free polymer phase. Here, the term “at least three phases” means that, in addition to the three phases mentioned, further phases may be present which, for their part, may each consist of
(a) amorphous particles of the crop protection agent; or
(b) a molecularly disperse distribution of the crop protection agent in a polymer matrix; or
(c) crop protection agent-free polymer particles.

In one embodiment of the present invention, the core of the nanoparticles according to the invention consists of at least two phases, one phase consisting of amorphous particles of the active compound and the other phase being a molecularly disperse distribution of the active compound in a polymer matrix. Here, the term “at least two phases” means that, in addition to the two phases mentioned, further phases may be present which, for their part, may each consist of
(a) amorphous particles of the crop protection agent; or
(b) a molecularly disperse distribution of the crop protection agent in a polymer matrix.

In a further embodiment of the present invention, the core of the nanoparticies according to the invention consists of at least two phases, one phase consisting of amorphous active compound and the other phase being an active compound-free polymer matrix. Here, the term “at least two phases” means that, in addition to the two phases mentioned, further phases may be present which, for their part, may consist of
(a) amorphous particles of the crop protection agent; or
(b) active compound-free polymer particles.

In a further preferred embodiment of the present invention, the core of the nanoparticles according to the invention consists of a molecularly disperse distribution of the active compound in a polymer matrix.

As mentioned above, the crop protection agent in the core is present X-ray amorphous form together with one or more polymers. The term “with one or more polymers” means that
(a) the polymer matrix in which the crop protection agent is distributed a molecularly disperse may consist of one, two, three or four polymers, preferably one or two polymers, particularly preferably one polymer;
(b) the crop protection agent-free polymer particles may consist of one, two, three or four polymers, preferably one or two polymers, particularly preferably one polymer, which may be different from or identical to the polymer of the polymer matrix.

In a preferred embodiment, the polymer in the crop protection agent-free particles is identical to the polymer in the polymer matrix.

Suitable for use as polymeric components present in the core of the particles of the crop protection agent preparation according to the invention are, in principle, all polymers which, in a temperature range between 0 and 240° C., a pressure range between 1 and 100 bar, a pH range of from 0 to 14 or ionic strengths of up to 10 mol/l, are not or only partially soluble in water or aqueous solutions or water/solvent mixtures.

In this context, not or only partially soluble means that the second virial coefficient for the polymer(s) in water or in a mixture of water and an organic solvent may assume values of less than zero (cf. M. D. Lechner, Makromolekulare Chemie [Macromolecular chemistry], BirkhauserVerlag, Basle, pp. 170-175). The second virial coefficient, which predicts the behavior of a polymer in a solvent (mixture), can be determined experimentally, for example by measuring light scattering or by determining the osmotic pressure. The dimension of this coefficient is (mol-l)/g².

It is possible to use one or more polymers. The molar masses of the polymers used are in the range of 1000-10000000 g/mol, preferably in the range of 1000-1000000 g/mol. In principle, all polymers suitable for application in crop protection may be used.

Suitable core polymers are polymers based on the following monomers:

Acrylamide, allyl methacrylate, alpha-methylstyrene, butadiene, butanediol dimethacrylate, butanediol divinyl ether, butanediol dimethacrylate, butanediol monoacrylate, butanediol monomethacrylate, butanediol monovinyl ether, butyl acrylate, butyl methacrylate, cyclohexyl vinyl ether, diethylene glycol divinyl ether, diethylene glycol monovinyl ether, ethyl acrylate, ethyl diglycol acrylate, ethylene, ethylene glycol butyl vinyl ether, ethylene glycol dimethacrylate, ethylene glycol divinyl ether, ethylhexyl acrylate, ethylhexyl methacrylate, ethyl methacrylate, ethyl vinyl ether, glycidyl methacrylate, hexanediol divinyl ether, hexanediol mononvinyl ether, isobutene, isobutyl acrylate, isobutyl methacrylate, isoprene, isopropylacrylamide, methyl acrylate, methylenebisacrylamide, methyl methacrylate, methyl vinyl ether, n-butyl vinyl ether, N-methyl-N-vinylacetamide, N-vinylcaprolactam, N-vinylimidazole, N-vinylpiperidone, N-vinylpyrrolidone, octadecyl vinyl ether, phenoxyethyl acrylate, polytetrahydrofuran-290 divinyl ether, propylene, styrene, tert-butylacrylamide, tert-butyl acrylate, tert-butyl methacrylate, tetraethylene glycol divinyl ether, triethylene glycol dimethyl acrylate, triethylene glycol divinyl ether, triethylene glycol divinyl methyl ether, trimethylolpropane trimethacrylate, trimethylolpropane trivinyl ether, vinyl 2-ethyl-hexyl ether, vinyl 4-tert-butylbenzoate, vinyl acetate, vinyl chloride, vinyl dodecyl ether, vinylidene chloride, vinyl isobutyl ether, vinyl isopropyl ether, vinyl propyl ether and vinyl tert-butyl ether.

The term polymer embraces both homo- and copolymers. Here, the person skilled in the art can control the desired insolubility in water of the core polymer by choosing suitable monomers and their relative proportions in the polymer. It is obvious that the hydrophilic monomers mentioned in the above enumeration have this desired insolubility only in combination with at least one further hydrophobic monomer and can thus, as homopolymers, not be used as core polymer.

Suitable copolymers are both random and alternating systems, block copolymers or graft copolymers. The term copolymers embraces polymers which are constructed of two or more different monomers or where at least one monomer can be incorporated into the polymer chain by various means, as is the case, for example, with stereo block copolymers.

The following polymers are mentioned by way of preference:

Polyvinyl ethers such as, for example, polybenzyloxyethylene, polyvinyl acetals, polyvinyl esters such as, for example, polyvinyl acetate, polyoxytetramethylene, polycarbonates, polyesters, polysiloxanes, polyurethanes, polyacrylamides such as, for example, poly(N-isopropylacrylamide), polymethacrylamides polyhydroxybutyrates, acetylated polyvinyl alcohols, polyacrylates such as, for example, polyphenoxyethyl acrylate, polymethyl acrylate, polyethyl acrylate, polydodecyl acrylate, poly(isobornyl acrylate), poly(n-butyl acrylate), poly(t-butyl acrylate), polycyclohexyl acrylate, poly(2-ethylhexyl acrylate), polyhydroxypropyl acrylate, polymethacrylates, such as, for example, polymethyl methacrylate, poly(n-amyi methacrylate), poly(n-butyi methacrylate), polyethyl methacrylate, poly(hydroxypropyl methacrylate), polycyclohexyl methacrylate, poly(2-ethylhexyl methacrylate), polylauryl methacrylate, poly(t-butyl methacrylate), polybenzyl methacrylate, poly(isobornyl methacrylate), polyglycidyl methacrylate and polystearyl methacrylate, polystyrene, and also copolymers based on styrene, for example with maleic anhydride, styrene/butadiene copolymers, methyl methacrylate/styrene copolymers, N-vinylpyrrolidone copolymers, polycaprolactones, polycaprolactams, poly(N-vinylcaprolactam), gufta-percha, cellulose ethers such as, for example, methylcellulose (degree of substitution 3-40%), ethylcellulose, butylcellulose, isopropylcellulose, cellulose esters such as, for example, cellulose acetate, starches, modified starches such as, for example, methyl ether starch, gum arabic, chitin, shellac, and also copolymers and block copolymers of the monomers of the abovementioned compounds.

Very particular preference is given to polyphenoxyethyl acrylate, polymethyl methacrylate, polystyrene and methyl methacrylate/styrene copolymers.

Of particular interest are furthermore biodegradable polymers.

The term “biodegradable polymers” is meant to comprise all polymers which meet the definition of biodegradability given in DIN V 54900, in particular compostible polyesters.

In general, biodegradability means that the polyesters decompose within an appropriate and demonstrable period. The degradation may be brought about hydrolytically and/or oxidatively, and is predominantly caused by the action of microorganisms such as bacteria, yeasts, fungi and algae. The biodegradability can be quantified, for example, by mixing polyester with compost and storing it for a certain period of time. By way of example, according to ASTM D 5338, ASTM D 6400 and DIN V 54900, CO₂-free air is passed through ripened compost during the composting process and the compost is subjected to a defined temperature profile. Biodegradability is determined here by way of the ratio of the net amount of CO₂ released from the sample (after deduction of the amount of CO₂ released by the compost without the specimen) to the maximum possible amount of CO₂ released by the sample (calculated from the carbon content of the sample), this ratio being defined as biodegradability. Even after a few days of composting, biodegradable polyesters generally show marked signs of degradation, for example fungal growth, cracking, and perforation.

Examples of biodegradable polymers are biodegradable polyesters such as, for example, polylactide, polyalkylene adipate terephthalates and polylactide glycoside. Particular preference is given to biodegradable polyalkylene adipate terephthalates, preferably polybutylene adipate terephthalates. Suitable polyalkylene adipate terephthalates are described, for example, in DE 4 440 858 (and are commercially available, for example Ecoflex® from BASF).

Compounds suitable for the coating matrix are interface- or surface-active polymeric colloids or the like, low-molecular-weight amphiphilic compounds or mixtures of these colloids and amphiphilic compounds.

In a preferred embodiment, the coating matrix consists of interface-active or surface-active polymeric protective colloids. Optionally, these interface-active or surface-active polymeric protective colloids may be mixed with low-molecular-weight amphiphilic compounds, resulting in a stabilization of these polymeric protective colloids.

Suitable low-molecular weight amphiphilic compounds are both ionic and nonionic surfactants.

Suitable ionic surfactants are, for example, alkylarylsulfonates, phenylsulfonates, alkyl sulfates, alkylsulfonates, alkyl ether sulfates, alkylaryl ether sulfates, alkyl polyglycol ether phosphates, polyarylphenyl ether phosphates, alkylsulfosuccinates, olefin-sulfonates, paraffinsulfonates, petroleumsulfonates, taurides, sarcosides, fatty acids, alkylnaphthalenesulfonic acids, naphthalenesulfonic acids, lignosulfonic acids, ligno-sulfite waste liquors, including their alkali metal, alkali earth metal, ammonium and amine salts, alkyl phosphates, quaternary ammonium compounds, alkyl phosphates, amine oxides, betaines and mixtures thereof.

Suitable nonionic surfactants are, for example, alkylphenol alkoxylates, alcohol alkoxylates, fatty amine alkoxylates, polyoxyethylene glycerol fatty esters, castor oil alkoxylates, fatty acid alkoxylates, fatty amide alkoxylates, fatty acid polydiethanol-amides, lanoline ethoxylates, fatty acid polyglycol esters, isotridecyl alcohol, fatty amides, fatty esters, silicone oils, alkyl polyglycosides, glycerol fatty esters.

Suitable interface- or surface-active polymeric protective colloids are also referred to as protective colloids and may be both synthetic polymers and biopolymers or modified biopolymers.

Examples of suitable synthetic protective colloids are polymers based on the following monomers:

2-methyl-N-vinylimidazole, acrylamide, arylamidomethylpropanesulfonic acid, acrylonitrile, acrylic acid, aminopropyl vinyl ether, butanediol monoacrylate, butanediol monomethacryate, butanediol monovinyl ether, butyl acrylate, butyl methacrylate, diethylaminoethyl vinyl ether, diethylene glycol monovinyl ether, dimethylaminoethyl acrylate, dimethylaminoethyl acrylate methochloride, dimethylaminoethyl methacrylate, dimethylaminoethyl methacrylate quaternized with methyl chloride, dimethylamino-propylmethacrylamide, ethyl acrylate, ethylene glycol monovinyl ether, ethylhexyl acrylate, ethylhexyl methacrylate, ethyl methacrylate, ethyl vinyl ether, hydroxyethyl acrylate, hydroxyethyl methacrylate, hydroxypropyl acrylate, hydroxypropyl methacrylate, isobutyl acrylate, isobutyl methacrylate, ispropylacrylamide, maleic anhydride, methacrylic acid, methacrylic anhydride, methyl acrylate, methyl methacrylate, methyl vinyl ether, N-methyl-N-vinylacetamide, N-vinylcaprolactam, N-vinylimidazole, N-vinylpiperidone, N-vinylpyrrolidone, phenoxyethyl acrylate, polytetrahydrofuran 290-divinyl ether, styrene, styrenesulfonic acid, tert-butyl-acrylamide, tert-butyl acrylate, tert-butyl methacrylate, vinyl 2-ethylhexyl ether, vinyl acetate, vinylformamide, vinyl isobutyl ether, vinyl isopropyl ether, vinyl propyl ether and vinyl tert-butyl ether, and also esters of acrylic acid or methacrylic acid with oligoethylene oxide or polyethylene oxide, for example monomethyl polyethylene oxide acrylic ester or monomethyl polyethylene oxide methacrylic ester, where the polyethylene oxide has a number-average molecular weight of from about 300 to about 5000 g/mol.

As appropriate, ionizable monomers can be present before, during or after polymerization in fully or partially neutralized form.

The term polymers embraces both homo- and copolymers. Here, the person skilled in the art can control the desired amphiphilicity of the coating polymer by choosing suitable monomers and their relative proportions in the polymer. It is obvious that the strongly hydrophobic monomers mentioned in the above enumeration have the desired amphiphilicity only in combination with at least one further hydrophilic monomer and can thus, as homopolymers, not be used as coating polymer.

Suitable copolymers are both random and alternating systems, block copolymers or graft copolymers. The term copolymers embraces polymers which are constructed of two or more different monomers or where at least one monomer can be incorporated into the polymer chain by various means, as is the case, for example, with stereo block copolymers.

Particularly preferred polymers are polyethylene glycol, polypropylene glycol, polyethylene glycol/polypropylene glycol block copolymers, polyethylene glycol alkyl ethers, polypropylene glycol alkyl ethers, polyethylene glycol/polypropylene glycol ether block copolymers, polyvinyl alcohol, polyvinylpyrrolidone, polyvinylcaprolactam, polyacrylamidomethylpropylsulfonic acid, polycarboxylates such as, for example, polyacrylic acid, polyacrylates, maleic anhydride/olefin copolymers (for example Sokalan®CP9, BASF), and also copolymers based on the monomers of these polymers, in addition to polyoxyethylene glycerol triricinoleate, and also the condensates of sulfonated naphthalenes or phenols with formaldehyde and, if appropriate, urea, which are present as water-soluble salts such as, for example, as sodium salt, such as naphthalenesulfonic acid/formaldehyde condensates or condensates of phenolsulfonic acid, formaldehyde and urea (for example compounds such as Wettol®D1, Tamol®NN, Tamol®NH from BASF or Morwet®D425 from Witco).

Examples of biopolymers or modified biopolymers suitable as protective colloids are gelatins, pectin, chitosan, starch, modified starch, dextrin, gum arabic, casein, caseinate, methylcellulose, carboxymethylcellulose, hydroxypropylcellulose and alginates.

In a preferred embodiment of the invention, a component used for the coating matrix is polyvinyl alcohol.

In a further preferred embodiment of the invention, a component used for the coating matrix is a maleic anhydride/olefin copolymer (for example Sokalan®CP9, BASF).

In a further preferred embodiment of the invention, a component used for the coating matrix is polyvinylpyrrolidone.

In a further preferred embodiment of the invention, a component used for the coating matrix is polyoxyethylene glycerol triricinoleate.

In a further preferred embodiment of the invention, a component used for the coating matrix is a naphthalene sulfone condensate (Na salt, for example Wettol®D2).

Poorly soluble crop protection agents are known to the person skilled in the art from the literature. The term crop protection agent means that here, at least one crop protection agent from the group of the insecticides, fungicides, herbicides and/or safeners (see Pesticide Manual, 13th Ed. (2003)) is selected for the present formulation.

Poorly soluble means that the solubility of the crop protection agent at room temperature is less than 500 mg/i in water.

Possible crop protection agents are shown in the list of insecticides below, but this list is not meant to be exhaustive:

A.1. Organo(thio)phosphates: azinphos-methyl, chlorpyrifos, chlorpyrifos-methyl, chlorfenvinphos, diazinon, disulfoton, ethion, fenitrothion, fenthion, isoxathion, malathion, methidathion, methyl-parathion, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;

A.2. Carbamates: alanycarb, bendiocarb, benfuracarb, carbaryl, carbofuran, carbosulfan, fenoxycarb, furathiocarb, methiocarb, methomyl, oxamyl, pirimicarb, thiodicarb, triazamate;

A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin;

A.4. Growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, a tetronic acid derivative of formula D′,

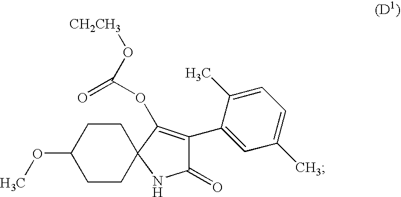

A.5. Nicotine receptor agonists/antagonists: clothianidin, dinotefuran, thiacloprid;

A.6. GABA antagonists: acetoprole, endosulfan, ethiprole, fipronil, vaniliprole;

A.7. Macrolide insecticides: abamectin, emamectin, milbemectin, lepimectin, spinosad;

A.8. METI I acaricides: fenazaquin, pyridaben, tebufenpyrad, tolfenpyrad;

A.9. METI II and III compounds: acequinocyl, fluacyprim, hydramethylnon;

A.10. Uncoupler compounds: chlorfenapyr;

A.11. Inhibitors of oxidative phosphorylation: cyhexatin, diafenthiuron, fenbutatin oxide, propargite;

A.12. Ecdysone antagonists: cryomazine;

A.13. Inhibitors of the mixed function oxidase: piperonyl butoxide;

A.14. Sodium channel blockers: indoxacarb, metaflumizone;

A.15. Various: benclothiaz, bifenazate, flonicamid, pyridalyl, pymetrozine, sulfur, thiocyclam and aminoisothiazole compounds of the formula D²,

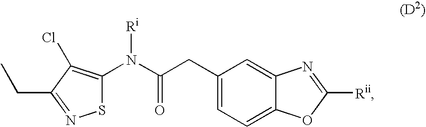

where Rⁱ is —CH₂OCH₂CH₃ or H and Rⁱⁱ is CF₂CF₂CF₃ or CH₂CH(CH₃)₃, anthranilamide compounds of the formula D³

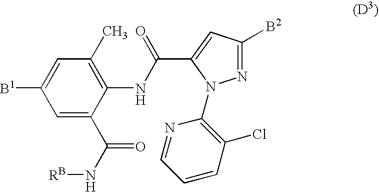

where B1 is hydrogen or chlorine, B2 is bromine or CF₃ and RB is CH₃ or CH(CH₃)₂, and malononitrile compounds as described in JP 2002 284608, WO 02/89579, WO 02/90320, WO 02/90321, WO 04/06677, WO 04/20399 or JP 2004 99597, N—R′-2,2-dihalo-1-R″-cyclopropanecarboxamide-2-(2,6-dichloro-α,α,α,α-trifluoro-p-tolyl)hydrazone or N—R′-2,2-di(R′″)propionamide-2-(2,6-dichloro-α,α,α,α-trifluoro-p-tolyl)hydrazone where R′ is methyl or ethyl, halo is chlorine or bromine, R″ is hydrogen or methyl and R′″ is methyl or ethyl.

The list of fungicides below shows possible active compounds, but is not meant to be limited to these:

1. Strobilurins, such as
azoxystrobin, dimoxystrobin, enestrostrobin, fluoxastrobin, kresoxim-methyl, metomino-strobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-(2,5-dimethylphenyloxymethylene)phenyl)-3-methoxyacrylate.

2. Carboxamides, such as
carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methyl-pyrazole-4-carboxamide, N-(2-cyanophenyl)-3,4-dichloroisothiazole-5-carboxamide;
carboxylic acid morpholides: dimethomorph, flumorph;
benzamides: flumetover, fluopicolide (picobenzamid), zoxamide;
other carboxamides: carpropamid, diclocymet, mandipropamid, N-(2-(4-[3-(4-chloro-phenyl)prop-2-ynyloxy]-3-methoxyphenyl)ethyl)-2-methanesulfonylamino-3-methyl-butyramide, N-(2-(4-[3-(4-chlorophenyl)prop-2-ynyloxy]-3-methoxyphenyl)ethyl)-2-ethanesulfonylamino-3-methylbutyramide;

3. Azoies, such as
triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;

4. Nitrogenous heterocyclyl compounds, such as
pyridines: fluazinam, pyrifenox, 3-[5-(4-chlorophenyl)-2,3-dimethylisoxazolidin-3-yl]-pyridine;
pyrimidines: bupirimate, cyprodinil, ferimzone, fenarimol, mepanipyrim, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
others: acibenzolar-S-methyl, anilazine, captan, captafol, dazomet, diclomezine, fenoxanil, folpet, fenpropidin, famoxadone, fenamidone, octhilinone, probenazole, proquinazid, quinoxyfen, tricyclazole, 5-chloro-7-(4-methylpiperidin-1-yl)-6-(2,4,6-tri-fluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;

5. Carbamates and dithiocarbamates, such as
carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

6. Other fungicides, such as
organometallic compounds: fentin salts;
sulfur-containing heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorothalonil, dichlofluanid, tolylfluanid, flusulfamide, phthalide, hexachlorobenzene, pencycuron, quintozene;
nitrophenyl derivatives: binapacryl, dinocap, dinobuton;
others: spiroxamine, cyflufenamid, cymoxanil, metrafenone.

The list of herbicides below shows possible active compounds, that is not meant to be limited to these:

Compounds which inhibit the biosynthesis of lipids, for example chlorazifop, clodinafop, ciofop, cyhalofop, ciciofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, or esters thereof, butroxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, thiocarbazil, triallate, vernolate, benfuresate, ethofumesate and bensulide;

ALS inhibitors, such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac; if the pH is <8 Compounds which inhibit photosynthesis, such as atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine and terbutryne; Protoporphyrinogen-IX oxidase inhibitors, such as acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen and etnipromid;

Herbicides, such as metflurazon, norflurazon, flufenican, diflufenican, picolinafen, beflubutamid, fluridone, flurochloridone, flurtamone, mesotrione, sulcotrione, isoxachiortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine and 3-heterocyclyl-substituted benzoyl derivatives of the formula (cf. WO-A-96/26202, WO-A-97/41116, WO-A-97/41117 and WO-A-97/41118)

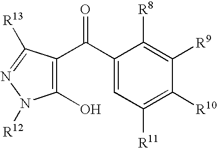

in which the substituents R⁸ to R¹³ are as defined below:
R⁸, R¹⁰ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl; R⁹ is a heterocyclic radical from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the radicals mentioned may carry one or more substituents; for example, they may be mono-, di-, tri- or tetrasubstituted by halogen, C₁-C₄-alkyl, C₁-C₄-alkoxy, C₁-C₄-haloalkyl, C₁-C₄-halo-alkoxy or C₁-C₄-alkylthio;
R¹¹=hydrogen, halogen or C₁-C₆-alkyl;
R¹²═C₁-C₆-alkyl;
R¹³=hydrogen or C₁-C₆-alkyl if the pH is <8.

Mitose inhibitors, such as benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, chlorthal, carbetamide, chlorpropham and propham;

VLCFA inhibitors, such as acetochlor, alachlor, butachlor, butenachlor, delachlor, diethatyl, dimethachlor, dimethenamid, dimethenamid-P, metazachlor, metolachlor, S-metolachlor, pretilachlor, propisochlor, prynachlor, terbuchlor, thenylchlor, xylachlor, CDEA, epronaz, diphenamid, napropamide, naproanilide, pethoxamid, flufenacet, mefenacet, fentrazamide, anilofos, piperophos, cafenstrole, indanofan and tridiphane; inhibitors of the biosynthesis of cellulose, such as dichlobenil, chlorthiamid, isoxaben and flupoxam;

herbicides, such as dinofenate, dinoprop, dinosam, dinoseb, dinoterb, DNOC, etinofen and medinoterb;

moreover: benzoylprop, flamprop, flamprop-M, bromobutide, chlorflurenol, cinmethylin, methyldymron, etobenzanid, pyributicarb, oxaziclomefone, triaziflam and methyl bromide.

The term “safener” is as defined below: it is known that, in some cases, better herbicide tolerance can be achieved by the joint application of herbicides having a specific action with organic active compounds which for their part may be herbicidally active. In these cases, these compounds act as antidote or antagonist and, because they reduce or prevent damage to useful plants, are referred to as “safeners”.

The following list shows possible safeners, but is not meant to be limited to these:

benoxacor, cloquintocet, cyometrinil, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloro-acetyl)-1-oxa-4-azaspiro[4.5]decane (AD-67; MON 4660) and oxabetrinil.

Preference is given to selecting a crop protection agent from the group of the fungicides or insecticides, particularly preferably from the group consisting of α-cyper-methrin, boscalid, pyraclostrobin, metconazole, epoxiconazole and metaflumizone, and very particularly preferably from the group consisting of α-cypermethrin, pyraclostrobin and metaflumizone.

In a further embodiment of the present invention, particular preference is given to the following combinations of polymer matrix, crop protection agent and coating component:

polymethyl methacrylate as polymer matrix, α-cypermethrin as crop protection agent and a coat of the amphiphilic polymer polyvinyl alcohol and optionally low-molecular-weight surfactants, such as sodium dodecyl sulfate (SDS).

Polymethyl methacrylate as polymer matrix, pyraclostrobin as crop protection agent and a coat of the amphiphilic polymer polyvinyl alcohol.

Poly(methyl methacrylate/styrene) as polymer matrix, pyraclostrobin as crop protection agent and a coat of the amphiphilic polymer polyvinyl alcohol.

Polyphenoxyethyl acrylate as polymer matrix, pyraclostrobin as crop protection agent and a coat of the amphiphilic polymer polyvinyl alcohol.

Polybutylene adipate terephthalate as polymer matrix, metaflumizone as crop protection agent and a coat of the amphiphilic polymer Na caseinate.

According to the invention, the quantities of the various components are chosen such that the preparations comprise from 0.1 to 70% by weight, preferably from 1 to 40% by weight, of active compound, from 1 to 80% by weight, preferably from 10 to 60% by weight, of one or more amphiphilic polymers (coating polymers), from 0.01 to 50% by weight, preferably 0.1 to 30% by weight, of one or more polymers for the core, and from 0 to 50% by weight, preferably from 0.5 to 10% by weight, of one or more surfactants. The percentages by weight are based on a dry powder obtainable from the dispersions mentioned above.

The aqueous dispersions mentioned above may optionally also comprise further formulation auxiliaries.

The term formulation auxiliaries describes surfactants, such as wetting agents, tackifiers or antifoams, thickeners, antifreeze agents, and also bactericides. Formulations intended for dressing seed may additionally also comprise adhesives and, if appropriate, pigments.

The importance and the appropriate use of the compositions mentioned above depends on the nature of the active compound.

Examples of thickeners (i.e. compounds which bestow on the formulation pseudo-plastic flow properties, e.g. high viscosity at rest and low viscosity in the agitated state) are, for example, polysaccharides and organic sheet minerals, such as xanthan gum (Kelzan® from Kelco), Rhodopol® 23 (Rhone Poulenc) or Veegum® (from R.T. Vanderbilt) or Attaclay® (from Engelhardt).

Suitable antifoams are, for example, silicon emulsions (such as, for example, Silikon® SRE, from Wacker, or Rhodorsil® from Rhodia), long-chain alcohols, fatty acids, organofluorine compounds and mixtures thereof.

It is possible to add bactericides to stabilize the aqueous fungicide formulation. Bactericides which may be present in the formulations according to the invention are all bactericides customary for formulating agrochemically active compounds, such as, for example, bactericides based on dichlorophene and benzyl alcohol hemiformal. Examples of bactericides are Proxel® from ICI or Acticide® RS from Thor Chemie and Kathon® MK from Rohm & Haas.

Suitable antifreeze agents are, for example, ethylene glycol, propylene glycol or glycerol.

Examples of surfactants are alkali metal, alkaline earth metal and ammonium salts of lignosulfonic acid, naphthalenesulfonic acid, phenolsulfonic acid, dibutylnaphthalene-sulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or naphtalenesulfonic acid with phenol and formaldehyde, polyoxyethylene octyl phenol ether, ethoxylated isooctyl phenol, octyl phenol, nonyl phenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Adhesives which may be present in the seed dressing formulations are all binders customarily used in seed dressings. Polyvinylpyrrolidone, polyvinyl acetate, polyvinyl alcohol and Tylose may be mentioned by way of preference.

Furthermore, it is optionally also possible to add colorants to the dispersions according to the invention. Suitable are all colorants customary for such purposes. Here, it is possible to use both sparingly water-soluble pigments and water-soluble dyes. Dyes known under the names Rhodamin B, C.I. Pigment Red 112 and C.I. Solvent Red 1 may be mentioned as examples, and also Pigment Blue 15:4, Pigment Blue 15:3, Pigment Blue 15:2, Pigment Blue 15:1, Pigment Blue 80, Pigment Yellow 1, Pigment Yellow 13, Pigment Red 112, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Ac d Blue 9, Acid Yellow 23, Basic Red 10, Basic Red 108.

The present invention furthermore provides solid crop protection formulations preparable by drying an aqueous dispersion according to the invention by known methods, which dispersion, as mentioned above, may optionally comprise further formulation auxiliaries. Alternatively, it is also possible to dry, by known methods, aqueous dispersions according to the invention comprising no further formulation auxiliaries. Subsequently, appropriate formulation auxiliaries may be added to the solid crop protection formulations.

In a further embodiment of the present invention, processes for preparing an agrochemical formulation are claimed, which processes comprise treating a solid carrier with a dispersion according to the invention or a solid crop protection formulation according to the invention, and also claimed are agrochemical formulations obtainable by the process mentioned above.

Here, the solid crop protection formulation according to the invention may be dispersed in a solvent. Suitable solvents which may be present in the seed dressing formulations according to the invention are all organic solvents which can be used in agrochemical compositions (including the solvents mentioned above) and water. Preference is given to ketones, such as methyl isobutyl ketone and cyclohexanone, furthermore amides, such as dimethylformamide, furthermore cyclic compounds, such as N-methyl-pyrrolidone, N-octylpyrrolidone, N-dodecylpyrrolidone, N-octylcaprolactam, N-dodecyl-caprolactam and γ-butyrolactone, additionally strongly polar solvents, such as dimethyl sulfoxide, furthermore aromatic hydrocarbons, such as xylene, moreover esters, such as propylene glycol monomethyl ether acetate, 5-dibutyl adipate, hexyl acetate, heptyl acetate, tri-n-butyl citrate, diethyl phthalate and di-n-butyl phthalate, and furthermore alcohols, such as ethanol, n- and isopropanol, n- and isobutanol, n- and isoamyl alcohol, benzyl alcohol and 1-methoxy-2-propanol. A particularly preferred solvent is water.

Suitable solid carriers are solid carrier materials or seed. In a preferred embodiment of the present invention, the solid carrier used is seed. In this case, the agrochemical formulation is dressed seed. The term “dressing” comprises all seed dressing methods known to the person skilled in the art (for example seed dressing, seed coating and pelleting).

Suitable solid carrier materials are, for example, mineral earths, such as silica gels, highly divided silicic acids, silicates, talc, kaolin, attaclay, limestone, lime, chalk, bole, loess, clay/alumina, talc, dolomite, diatomaceous earth, calcium sulfate and magnesium sulfate, magnesium oxide and also ground synthetic materials, fertilizers, such as, for example, ammonium sulfate, ammonium phosphate, ammonium nitrate, ureas and products of vegetable origin, such as cereal meal, tree bark meal, wood meal and nut shell meal, cellulose powder and other solid carrier materials.

The term “seed” comprises seed of all types, such as, for example, grains, seeds, fruits, tubers, seedlings and similar forms. Here, the term “seed” preferably describes grains and seeds.

Suitable seed is seed of cereals, grain crops, root crops, oil crops, vegetables, spices, ornamentals, for example seed of durum and other wheat, barley, oats, rye, corn (fodder corn and sugar corn), soybeans, oil crops, crucifers, cotton, sunflowers, bananas, rice, oil seed rape, turnip, sugar beet, fodder beat, egg plants, potatoes, grass, lawn, turf, fodder grass, tomatoes, leek, pumpkin/squash, cabbage, iceberg lettuce, pepper, cucumbers, melons, Brassica spp., melons, beans, peas, garlic, onions, carrots, tuberous plants, such as sugarcane, tobacco, grapes, petunias, geranium/pelargonium, pansies, touch-me-not, preferably wheat, corn, soybeans and rice.

It is also possible to use the seed of transgenic plants or plants obtained by customary breeding methods as seed.

Thus, it is possible to use seed tolerant to herbicides, fungicides or insecticides, for example, plants resistant to sulfonylureas, imidazolinones or glufonsinate or glyphosate (see, for example, EP-A-0242236, EP-A-242246) (WO 92/00377) (EP-A-0257993, U.S. Pat. No. 5,013,659) or in transgenic plants, for example cotton, which produce Bacillus thuringiensis toxin (Bt toxins) and which are thus resistant to certain harmful organisms (EP-A-0 142924, EP-A-0 193259).

It is furthermore also possible to use seed of plants which, compared to customary plants, have modified properties. Examples of these are modified starch synthesis (e.g. WO 92/11376, WO 92/14827, WO 91/19806) or fatty acid compositions (WO 91/13972).

The present invention also claims methods for controlling unwanted vegetation and/or for controlling unwanted infestation by insects or mites on plants and/or for controlling phytopathogenic fungi, which methods comprise treating seeds of useful plants as described above with a dispersion according to the invention or a solid crop protection formulation according to the invention.

The present invention also claims methods for controlling unwanted vegetation and/or for controlling unwanted infestation by insects or mites on plants and/or for controlling phytopathogenic fungi, which methods comprise treating the fungi/insects, their habitat or the soils or plants to be protected against infestation by fungi or insects or the unwanted plants, the soil on which the unwanted plants grow, or seed thereof with a dispersion according to the invention or a solid crop protection formulation according to the invention or an agrochemical formulation according to the invention in which a solid carrier material is used as solid carrier.

The term phytopathogenic fungi describes the following species, but is not limited thereto: Alternaria spp. on rice, vegetables, soybeans, oilseed rape, sugarbeet and fruits, Aphanomyces spp. on sugarbeet and vegetables, Bipolaris and Drechslera spp. on corn, cereal, rice and ornamental lawn, Blumeria graminis (powdery mildew) on cereal, Botrytis cinerea (gray mold) on strawberries, vegetables, ornamental flowers, grapevines, Bremia lactucae on lettuce, Cercospora spp. on corn, soybean and sugarbeet, Cochliobolus spp. on corn, cereal, rice (e.g. Cochliobolus sativus on cereal, Cochliobolus miyabeanus on rice), Colletotrichum spp. on soybean and cotton, Drechslera spp. on cereal and corn, Exserohilum spp. on corn, Erysiphe cichoracearum and Sphaerotheca fuliginea on cucumbers, Erysiphe necator on grapevines, Fusarium and Verticillium spp. on various plants, Gaeumannomyces graminis on cereal, Gibberella spp. on cereal and rice (e.g. Gibberella fujikuroi on rice, Gibberella zeae on cereal), Grainstaining complex on rice, Microdochium nivale on cereal, Mycosphaerella spp. on cereal, bananas and peanuts, Phakopsora pachyrhizi and Phakopsora meibomiae on soybeans, Phomopsis spp. on soybeans and sunflowers, Phytophthora infestans on potatoes and tomatoes, Plasmopara viticola on grapevines, Podosphaera leucotricha on apples, Pseudocercosporella herpotrichoides on wheat and barley, Pseudoperonospora spp. on hops and cucumber, Puccinia spp. on cereal and corn, Pyrenophora spp. on cereal, Pyricularia oryzae on rice, Cochliobolus miyabeanus and Corticium sasakii (Rhizoctonia solani), Fusarium semitectum (and/or moniliforme), Cercospora oryzae, Sarocladium oryzae, S attenuatum, Entyloma oryzae, Gibberella fujikuroi (bakanae), Grainstaining complex (various pathogens), Bipolaris spp., Drechslera spp. and Pythium and Rhizoctonia spp. on rice, corn, cotton, sunflower, oilseed rape, (canola, oilseed rape), vegetables, ornamental lawn, nuts and other plants, Rhizoctonia solani on potatoes, Sclerotinia spp. on oilseed rape spp. (canola/oilseed rape) and sunflower, Septoria tritici and Stagonospora nodorum on wheat, Uncinula necator on grapevines, Sphacelotheca reiliana on corn, Thievaliopsis spp. on soybeans and cotton, Tilletia spp. on cereals, Ustiiago spp. on cereal, corn, sugar cane and, Venturia spp. (scab) on apples and pears.

The term unwanted insects or mites describes the following genera, but is not limited thereto:

millipedes (Diplopoda), for example, Blaniulus spp.,

ants (Hymenoptera), for example, Atta capiguara, Atta cephalotes, Atta laevigata, Atta robusta, Atta sexdens, Atta texana, Monomorium pharaonis, Solenopsis geminata, Solenopsis invicta, Pogonomyrmex spp. and Pheidole megacephala, beetles (Coleoptera), for example, Agrilus sinuatus, Agriotes lineatus, Agriotes obscurus and other Agriotes spp., Amphimallus solstitialis, Anisandrus dispar, Anthonomus grandis, Anthonomus pomorum, Aracanthus morei, Atomaria linearis, Blapstinus spp., Blastophagus piniperda, Blitophaga undata, Bothynoderes punciventris, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus and other Conoderus spp., Conorhynchus mendicus, Crioceris asparagi, Cylindrocopturus adspersus, Diabrotica (longicornis) barberi, Diabrotica semi-punctata, Diabrotica speciosa, Diabrotica undecimpunctata, Diabrotica virgifera and other Diabrotica spp., Eleodes spp., Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus and other Limonius spp., Lissorhoptrus oryzophilus, Listronotus bonariensis, Melanotus communis and other Melanotus spp., Meligethes aeneus, Melolontha hippocastani, Melolontha melolontha, Oulema oryzae, Ortiorrhynchus sulcatus, Oryzophagus oryzae, Otiorrhynchus ovatus, Oulema oryzae, Phaedon cochleariae, Phyllotreta chrysocephala, Phyllophaga cuyabana and other Phyllophaga spp., Phyllopertha horticola, Phyllotreta nemorum, Phyllotreta striolata, and other Phyllotreta spp., Popillia japonica, Promecops carinicollis, Premnotrypes voraz, Psylliodes spp., Sitona lineatus, Sitophilus granaria, Sternechus pinguis, Sternechus subsignatus, and Tanymechus palliatus and other Tanymechus spp.,

flies (Diptera), for example, Agromyza oryzea, Chrysomya bezziana, Chrysomya hominivorax, Chrysomya macellaria, Contarinia sorghicola, Cordylobia anthropophaga, Dacus cucurbitae, Dacus oleae, Dasineura brassicae, Delia antique, Delia coarctata, Delia platura, Delia radicum, Fannia canicularis, Gasterophilus intestinalis, Geomyza Tripunctata, Glossina morsitans, Haematobia irritans, Haplodiplosis equestris, Hypoderma lineata, Liriomyza sativae, Liriomyza trifolii, Lucilia caprina, Lucilia cuprina, Lucilia sericata, Lycoria pectoralis, Mayetiola destructor, Muscina stabulans, Oestrus ovis, Opomyza fiorum, Oscinelia frit, Pegomya hysocyami, Phorbia antiqua, Phorbia brassicae, Phorbia coarctata, Progonya leyoscianii, Psila rosae, Rhagoletis cerasi, Rhagoletis pomonella, Tabanus bovinus, Tetanops myopaeformis, Tipula oleracea and Tipula paludosa,

heteropterans (Heteroptera), for example, Acrosternum hilare, Blissus leucopterus, Cicadellidae such as, for example Empoasca fabae, Chrysomelidae, Cyrtopeltis notatus, Delpahcidae, Dysdercus cingulatus, Dysdercus intermedius, Eurygaster integriceps, Euschistus impictiventris, Leptoglossus phyllopus, Lygus lineolaris, Lygus pratensis, Nephotettix spp., Nezara viridula, Pentatomidae, Piesma quadrata, Solubea insularis and Thyanta perditor,

aphids and other homopterans (Homoptera), e.g. Acyrthosiphon onobrychis, Adelges laricis, Aphidula nasturtii, Aphis fabae, Aphis forbesi, Aphis glycines, Aphis gossypii, Aphis grossulariae, Aphis pomi, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes (Myzus) persicae, Myzus ascalonicus, Myzus cerasi, Myzus varians, Nasonovia ribis-nigri, Nilaparvata lugens, Pemphigus bursarius, Pemphigus populivenae, and other Pemphigus spp., Perkinsiella saccharicida, Phorodon humuli, Psyllidae, such as, for example Psylla mali, Psylla piri and other Psylla spp., Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii;

lepidoptera, for example Agrotis ypsilon, Agrotis segetum and other Agrotis spp., Alabama argillacea, Anticarsia gemmatalis, Argyresthia conjugella, Autographa gamma, Bupalus piniarius, Cacoecia murinana, Capua reticulana, Cheimatobia brumata, Chilo suppresalis and other Chilo spp., Choristoneura fumiferana, Choristoneura occidentalis, Cirphis unipuncta, Cnaphlocrocis medinalis, Cydia pomonella, Dendrolimus pini, Diaphania nitidalis, Diatraea grandiosella, Earias insulana, Elasmopalpus lignosellus, Eupoecilia ambiguella, Euxoa spp., Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Lerodea eufala, Leucoptera coffeella, Leucoptera scitella, Lithocolletis blancardelia, Lobesia botrana, Loxostege sticticalis, Lymantria dispar, Lymantria monacha, Lyonetia clerkella, Malacosoma neustria, Mamestra brassicae, Momphidae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sesamia nonagrioides and other Sesamia spp., Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

orthoptera, for example, Acrididae, Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus

termites (Isoptera), for example, Calotermes flavicollis, Coptotermes spp., Dalbulus maidis, Leucotermes flavipes, Macrotermes gilvus, Reticulitermes lucifugus and Termes natalensis;

thrips (Thysanoptera), for example, Frankliniella fusca, Frankliniella occidentalis, Frankliniella tritici and other Frankliniella spp., Scirtothrips citri, Thrips oryzae, Thrips palmi, Thrips simplex and Thrips tabaci,

arachnids, for example, Acarina, for example of the families Argasidae, lxodidae and Sarcoptidae, for example, Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp., for example, Aculus schlechtendali, Phyllocoptrata oleivora and Eriophyes sheldoni; Tarsonemidae spp., for example, Phytonemus pallidus and Polyphagotarsonemus latus; Tenuipalpidae spp., for example, Brevipalpus phoenicis; Tetranychidae spp., for example, Tetranychus cinnabarinus, Tetranychus kanzawai, Tetranychus pacificus, Tetranychus telarius and Tetranychus urticae, Panonychus ulmi, Panonychus citri, and Oligonychus pratensis;

nematodes, in particular plant-parasitic nematodes, for example, root knot nematodes, Meloidogyne hapla, Meloidogyne incognita, Meloidogyne javanica, and other meloidogyne spp.; cyst-forming nematodes, Globodera rostochiensis and other globodera spp.; Heterodera avenae, Heterodera glycines, Heterodera schachtii, Heterodera trifolii, and other heterodera spp.; seed gall nematodes, anguina spp.; stem and foliar nematodes, aphelenchoides spp.; sting nematodes, Belonolaimus longicaudatus and other belonolaimus spp.; pine nematodes, Bursaphelenchus xylophilus and other bursaphelenchus spp.; ring nematodes, criconema spp., criconemella spp., criconemoides spp., mesocriconema spp.; stem and bulb nematodes, Ditylenchus destructor, Ditylenchus dipsaci and other ditylenchus spp.; awl nematodes, dolichodorus spp.; spiral nematodes, Heliocotylenchus multicinctus and other helicotylenchus spp.; sheath und sheathoid nematodes, hemicycliophora spp. and hemicriconemoides spp.; hirshmanniella spp.; lance nematodes, hoploaimus spp.; false rootknot nematodes, nacobbus spp.; needle nematodes, Longidorus elongatus and other longidorus spp.; lesion nematodes, Pratylenchus neglectus, Pratylenchus penetrans, Pratylenchus curvitatus, Pratylenchus goodeyi and other Pratylenchus spp.; burrowing nematodes, Radopholus similis and other radopholus spp.; reniform nematodes, Rotylenchus robustus and other rotylenchus spp.; Scutellonema spp.; stubby root nematodes, Trichodorus primitivus and other trichodorus spp., paratrichodorus spp.; stunt nematodes, Tylenchorhynchus claytoni, tylenchorhynchus dubius and other tylenchorhynchus spp.; citrus nematodes, tylenchulus spp.; dagger nematodes, xiphinema spp.; and other plant-parasitic nematodes.

Control of unwanted vegetation means the control/destruction of plants growing on sites where they are unwanted, for example of

Dicotyledonous plants of the species: Sinapis, Lepidium, Galium, Stellaria, Matricaria, Anthemis, Galinsoga, Chenopodium, Urtica, Senecio, Amaranthus, Portulaca, Xanthium, Convolvulus, lpomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

Monocotyledonous plants of the species: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, lschaemum, Sphenoclea, Dactyloctenium, Agrostis, Alopecurus, Apera.

### EXAMPLES

### Example 1

A) Preparation of the Emulsion

10 g of pyraclostrobin and 30 g of PMMA (technical-grade polymethyl methacrylate, type: Lucryl G77, Batch: 5695/11) were dissolved in 170 g of dichloromethane. A clear, slightly viscous solution was formed. 30 g of polyvinyl alcohol (87-89%, hydrolyzed, MW: 13 000-23 000 g/mol) were dissolved in 2 kg of demineralized water.

The two solutions mentioned above were mixed in a mixing chamber. To this end, the pyraclostrobin solution, using a pump rate of 2 kg/h, was mixed in a mixing cell with the polyvinyl alcohol solution, flow rate 20 kg/h. Using a Brookhaven Instruments BI 90 (PCS) type instrument, the mean particle size was determined by quasi-elastic light scattering as 328 nm.

B) Preparation of the Concentrate

The dichloromethane was then removed in a rotary evaporator (bath temperature 40° C., pressure <50 mbar). Using a Brookhaven Instruments BI 90 (PCS) type instrument, the mean particle size was then determined by quasi-elastic light scattering as 332 nm.

### Example 2

A) Preparation of the Emulsion

10 g of pyraclostrobin and 30 g of PMMA (technical-grade polymethyl methacrylate, type: Lucryl G77, Batch: 5695/11) were dissolved in 170 g of dichloromethane. A clear, slightly viscous solution was formed. 30 g of polyvinyl alcohol (87-89%, hydrolyzed, MW: 13 000-23 000 g/mol) were dissolved in 2 kg of demineralized water.

The two solutions mentioned above were mixed in a mixing chamber. To this end, the pyraclostrobin solution, using a pump rate of 2 kg/h, was mixed in a mixing cell with the polyvinyl alcohol solution, flow rate 20 kg/h. Using a Brookhaven Instruments BI 90 (PCS) type instrument, the mean particle size was determined by quasi-elastic light scattering as 328 nm.

B) Preparation of the Concentrate

The dichloromethane was then removed in a rotary evaporator (bath temperature 40° C., pressure <50 mbar). Using a Brookhaven Instruments BI 90 (PCS) type instrument, the mean particle size was then determined by quasi-elastic light scattering as 332 nm.

### Example 3

A) Preparation of the Emulsion

5 g of pyraclostrobin and 15 g of PMMA (technical-grade polymethyl methacrylate, Batch: 5695/11) were dissolved in 180 g of dichloromethane. A clear, slightly viscous solution was formed. 15 g of polyvinyl alcohol (87-89%, hydrolyzed, MW: 13 000-23 000 g/mol) were dissolved in 2 kg of demineralized water.

The two solutions mentioned above were mixed in a mixing chamber. To this end, the pyraclostrobin solution, using a pump rate of 2 kg/h, was mixed in a mixing cell with the polyvinyl alcohol solution, flow rate 20 kg/h. Using a Brookhaven Instruments BI 90 (PCS) type instrument, the mean particle size was determined by quasi-elastic light scattering as 340 nm.

B) Preparation of the Concentrate

The dichloromethane was then removed in a rotary evaporator (bath temperature 40° C., pressure <50 mbar). Using a Brookhaven Instruments BI 90 (PCS) type instrument, the mean particle size was then determined by quasi-elastic light scattering as 336 nm.

### Example 4

A) Preparation of the Emulsion

2.5 g of pyraclostrobin and 7.5 g of PMMA (technical-grade polymethyl methacrylate, Batch: 5695/11) were dissolved in 190 g of dichloromethane. A clear, slightly viscous solution was formed. 7.5 g of polyvinyl alcohol (87-89%, hydrolyzed, MW: 13 000-23 000 g/mol) were dissolved in 2 kg of demineralized water.

The two solutions mentioned above were mixed in a mixing chamber. To this end, the pyraclostrobin solution, using a pump rate of 2 kg/h, was mixed in a mixing cell with the polyvinyl alcohol solution, flow rate 20 kg/h. Using a Brookhaven Instruments BI 90 (PCS) type instrument, the mean particle size was determined by quasi-elastic light scattering as 311 nm.

B) Preparation of the Concentrate

The dichloromethane was then removed in a rotary evaporator (bath temperature 40° C., pressure <50 mbar). Using a Brookhaven Instruments BI 90 (PCS) type instrument, the mean particle size was then determined by quasi-elastic light scattering as 297 nm.

1-13. (canceled)

14. An aqueous dispersion comprising a nanoparticulate formulation of crop protection agents in which the nanoparticles comprise
an X-ray amorphous core-shell structure having a mean particle diameter of 0.05 to 2.0 μm and comprising a crop protection agent and one or more polymers, wherein the one or more polymers is not or is only partially soluble in water or aqueous solutions or water/solvent mixtures; and
a shell consisting of a stabilizing coating matrix;
wherein said nanoparticles are prepared by a process comprising
(a) preparing a solution of the crop protection agent in a water-immiscible organic solvent,
(b) dissolving the core polymer in a water-immiscible organic solvent; and
(c) emulsifying the mixture resulting from (a) and (b) with an aqueous solution comprising components of the coating matrix by injecting the corresponding solutions into a mixing chamber and removing the organic solvent after emulsification.

15. The dispersion of claim 14, wherein the core of the nanoparticles consists of at least two phases, wherein one phase consisting of amorphous particles of the active compound and the other phase being a molecularly disperse distribution of the active compound in a polymer matrix.

16. The dispersion of claim 14, wherein the core of the nanoparticles comprises at least two separate phases, wherein one phase consisting of amorphous active compound and the other phase being an active compound-free polymer matrix.

17. The dispersion of claim 14, wherein the core of the nanoparticles consists of a molecularly disperse distribution of the active compound in a polymer matrix.

18. The dispersion of claim 14, wherein the one or more core polymers is water-insoluble polymers selected from the group consisting of polymethyl methacrylate, polyphenoxyethyl acrylate, polymethyl acrylate, polydimethylaminopropylmethacrylamide, polystyrene, polylauryl acrylate, polyvinyl-caprolactam, copolymers and block copolymers of the monomers mentioned above, and biodegradable polyesters.

19. A nanoparticulate formulation, wherein an aqueous dispersion of claim 14 is dried.

20. An agrochemical formulation of a solid carrier treated with a dispersion of claim 14.

21. The agrochemical formulation of claim 20, wherein the solid carrier is seed.

22. The agrochemical formulation of claim 20, wherein the solid carrier is a solid carrier material.

23. A solid crop protection formulation comprising the formulation of claim 19.

24. A process for preparing an agrochemical formulation or for dressing seed, which comprises treating a solid carrier with the dispersion of claim 14.

25. A process for preparing an agrochemical formulation or for dressing seed, which comprises treating a solid carrier with the solid crop protection formulation of claim 23.

26. A method for controlling unwanted vegetation, infestation by insects or mites on plants, or phytopathogenic fungi, which comprises treating seed of useful plants with the dispersion of claim 14.

27. A method for controlling unwanted vegetation, infestation by insects or mites on plants, or phytopathogenic fungi, which comprises treating seed of useful plants with the solid crop protection formulation of claim 23.

28. A method for controlling unwanted vegetation, infestation by insects or mites on plants, or phytopathogenic fungi, which comprises treating seed of useful plants with the agrochemical formulation of claim 22.

29. A method for controlling unwanted vegetation, infestation by insects or mites on plants, or phytopathogenic fungi, which comprises treating the fungi/insects, their habitat or the soils or plants to be protected against infection by fungi or insects or the unwanted plants, the soil on which the unwanted plants grow or seed thereof with the dispersion of claim 14.

30. A method for controlling unwanted vegetation, infestation by insects or mites on plants, or phytopathogenic fungi, which comprises treating the fungi/insects, their habitat or the soils or plants to be protected against infection by fungi or insects or the unwanted plants, the soil on which the unwanted plants grow or seed thereof with the solid crop protection formulation of claim 23.

31. A method for controlling unwanted vegetation, infestation by insects or mites on plants, or phytopathogenic fungi, which comprises treating the fungi/insects, their habitat or the soils or plants to be protected against infection by fungi or insects or the unwanted plants, the soil on which the unwanted plants grow or seed thereof with the agrochemical formulation of claim 22.
